(19) United States
(12) Patent Application Publication
(10) Pub. No.: US 2017/0135381 A1
(43) Pub. Date: May 18, 2017

(54) Weight management method and associated high fiber natural food blend

(71) Applicant: James William Brennan, Stephenson, VA (US)

(72) Inventor: James William Brennan, Stephenson, VA (US)

(21) Appl. No.: 14/941,631

(22) Filed: Nov. 15, 2015

(51) Int. Cl. A23K 1/18

(52) U.S. Cl. CPC A23L 1/293; A23L 1/296; A23L 1/1016; A23V 2002/00

(57) ABSTRACT

A weight management program compatible with a dieter's food preferences and lifestyle and a natural high fiber dietary food blend derived from grains. The food blend contains a chew inducing grain and at least 40 grams of total dietary fiber in a volume that may vary from one cup to two cups. Initially, the dieter consumes a relatively small quantity of the high fiber food blend, and gradually increases the amount consumed on successive days until the dieter consumes a full portion food blend which contains at least 40 grams of total dietary fiber or a personal full portion compatible with his or her eating habits that contains between 30 and 40 grams of total dietary fiber. The dieter continues to consume that portion of the food blend on succeeding days and gradually adopts healthy eating behaviors without modification of lifestyle. Upon reaching a desired weight, the dieter adjusts the amount of the high fiber dietary food consumed while maintaining the acquired healthy and enjoyable eating behaviors.

### BACKGROUND OF THE INVENTION

### Field of Invention

This invention relates to a weight reduction program carried out in a manner compatible with a dieter's lifestyle and food preferences to foster long term adherence to sustainable and enjoyable healthy eating practices, and a natural ultra-high fiber food for use in such program.

### The Problem

Overweight and obesity is world wide problem. In the United States, about 79 million suffer from obesity, a condition linked to a range of diseases including heart disease, stroke, type 2 diabetes and certain types of cancer—some of the leading causes of preventable death. Furthermore, the percentage of Americans suffering from obesity is rising. According to the JAMA Internal Medicine, 75 percent of American men and 67 percent of women ages 25 and older are overweight or obese. The Washington Post commented (June 2015) “That's a . . . depressing sign that campaigns to get Americans to eat healthier and exercise more may he failing.”

Current Weight Loss Programs

The Food and Drug Administration (FDA) has approved a number of over-the-counter and prescription diet pills for suppressing appetite or inhibiting metabolism of fats. Most are for short term use. Some of these may also reduce absorption of certain vitamins. Furthermore, many people tend to reject diet products that contain ingredients with “chemical” names and seek out “natural” foods and diets.

There are a variety of diet programs available to address the problem. Many are successful in the short term—few are successful in the long term. There are several reasons why long-term dieting success is elusive.

Most diets require the dieter to alter his or her lifestyle and food preferences to those of the diet. High protein diets that replace fats and carbohydrates with protein have had good short term success rates. But, in the long term, most dieters find it too difficult to cut carbohydrates and fats out of their diet

Some diets require adding and subtracting foods during each “phase” of the diet plan. Others couple diet restrictions with dietary supplements that must be consumed each day. (See for example U.S. Pat. No. 4,737, 364 Kalogris). Others require participants to purchase prepackaged meals. Plans that require special food at every meal, often with special preparation, intrude upon the lifestyle of the dieter. Persons on vacation, attending a sports event, participating in a business luncheon or just enjoying a meal with friends often depart from the diet plan. Over time, it becomes just too difficult to follow the program and the dieter returns to his or her usual eating habits. The additional cost of a pre-packaged meal for one person of a family increases total meal costs for the family thus adding an expense that can also affect lifelong commitment to the diet.

According to researchers at the National Institutes of Health (NIH), diets requiring strict control of food intake are unrealistic in a free-living society (Journal of Cell Metabolism on Aug. 13, 2015). The American Dietetic Association suggests that successful weight management for adults requires adoption of behaviors emphasizing sustainable and enjoyable eating practices. (Journal of the American Dietetic Association Volume 102, Issue 8, August 2002,). Current diet programs lack that essential feature.

Dietary Fiber

In the 1970′s, medical experts Burkitt and Trowell coined the term “dietary fiber” and hypothesized that lack of dietary fiber was responsible for the higher incidence of cancer in Europeans compared to rural Africans who consume large amounts of food high in dietary fiber.

Dietary fiber is the edible portion of plant foods, including fruits, vegetables, whole grains, beans, nuts and seeds that is resistant to digestion and absorption in the small intestine. Dietary fiber contains a blend of bioactive components including resistant starches, vitamins, minerals, phytochemicals and antioxidants. There are two broad categories of dietary fiber—insoluble dietary fiber (IDF) and soluble dietary fiber (SDF). IDF provides bulk in the diet thereby promoting a long lasting sense of satiety. SDF dissolves in water and forms a gel that swells in size which allows it to move slowly through the digestive tract, making the stomach feel fuller for a longer time. So that consumption of dietary fiber promotes satiety and decreases postmeal hunger.

In the decades since the initial work of Burkitt and Trowell, researchers have focused on the health benefits of dietary fiber. A recent short term study, funded by NIH and the National Institute for Health Research Imperial Biomedical Research Centre in the United Kingdom, is one of many that support their dietary fiber hypothesis. When a group of black Americans switched from a typical American diet which contains about 15 grams of dietary fiber to a high fiber diet of South Africans, certain risk factors for colon cancer diminished. The change was rapid, suggesting the power of a high fiber diet to alter colon cancer risk. “Our study suggests that Westernization of the diet induces changes in [signals] of colon cancer risk within two weeks,” study co-author Stephen O'Keefe, of the University of Pittsburgh, said in a news release from the Imperial College London.

It is now well accepted that diets high in fiber are inversely associated with risk for heart disease and diabetes as well as improved digestion. A comprehensive review of the growing number of studies about the effects of dietary fiber and its components on metabolic health by J. M. Latimer and M. D. Haub can be found in a National Center for Biotechnology Information article dated December 2010 and published on line by the National Library of Medicine. (ncbi.nlm.nih.gov/pmc/articles/PMC3257631/)

Dietary fiber can also be one element of a successful weight loss diet, since it increases satiety, decreases postmeal hunger, and may also diminish energy metabolism. For example, the published patent application of Rusing and Hausmanns (Pub. No. US20070010480 Al) teaches a combination dietary food item composed of long chain omega 3 fatty acids and a relatively small amount of dietary fiber (10 grams) derived from resistant starch, fructooligosacharides, oligofructoses and inulin or a mixture thereof.

A recent study conducted at the University of Massachusetts Medical School and published in the Feb. 16, 2015 issue f the Annals of Internal e indicates that boosting dietary fiber consumption to 30 grams per day may be a somewhat effective approach to weight loss. A more recent study, based upon a mathematical model constructed by University of Nebraska agricultural economists Azzeddine Azzam and Sarah Rehkarnp suggests that, without cutting calories, Americans could reduce BMI by almost 10% by adopting a diet that includes higher levels of plant based foods and less animal based foods.

The Department of Agriculture recommends a daily intake of 25 g/day TDF. The National Cancer Institute and the American Diabetes Association recommend 20-30 g/day. The World Health Organization suggests between 27 to 40 g/day. The Federation of American Societies of Experimental Biology recommends consumption of 20-35 g/day. The average American consumes about 15 grams of dietary fiber a day; far below the amount recommended for adults by those organizations. In an effort to increase fiber consumption by Americans, some food producers have begun adding concentrated “functional fibers” to their foods and beverages. Functional fibers such as soluble corn fiber are isolates of dietary fibers having similar physiological properties to the dietary fibers from which they are derived. Furthermore, studies have demonstrated that soluble corn fiber is well tolerated even at intake levels of 65 g/day

The officially recommended consumption levels of TDF are based on the fiber intake that could be expected by switching to “a healthy diet” by eating more fruit, nuts and whole grains, not the level of fiber consumption appropriate to address a medical problem such as obesity. A short term study reported in the New England Journal of Medicine in 2000 indicated that much higher levels of TDF daily consumption are well tolerated and are beneficial. The study did not address the effect of high fiber consumption on weight, but concluded that patients with type 2 diabetes on a diet of 50 g/day TDF experienced improved glycemic control, compared to patients following American Diabetes Association recommendation of 20-30 g/day.

In some areas of the world daily consumption of TDF is well above the amount recommended for Americans. According to the CRC Handbook of Dietary Fiber in Human Nutrition (3rd Edition Jun. 27, 2001) dietary fiber intake in some parts of Mexico is as high as 94 grams per day, mostly from grains and legumes, and colon cancer rates are low (20/100,000). The Handbook indicates that in several countries of sub-Saharan Africa consumption of dietary fiber also is high: 69 grams per day for rural Nigerians, 70 grams per day in Uganda and 86 grams per day for the Kikuyu people of Kenya.

None of the research regarding consumption of dietary suggests that the time of day when the dietary fiber is consumed influences its efficacy. The recommended amount could be consumed at various times of the day, or be eaten at one meal.

Elements of a Successful Long Term Weight Loss Diet

.An effective long term weight reduction program must have a psychological aspect as well as a physiological component. To attract potential dieters, the program must be recognized as natural and healthful. It should not mandate abrupt changes to the dieter's life style. It should provide for increased consumption of a food high in dietary fiber, at a level that the dieter can easily tolerate. The program must he simple to follow and be compatible with the dieter's food preferences. That is, it should not proscribe consumption of certain foods so that the dieter is free to consume additional foods of choice. Increased dietary fiber consumption imparts a lasting sense of satiety and, over time, subtly affects the dieter's other food choices. In addition to eating the high fiber food, the dieter must commit to “eat responsibly” which requires two things; to decide prior to eating what and how much to eat and to chew food thoroughly. Eating fast, taking large bites, and swallowing quickly promote overeating, and is associated with higher body weight. More thorough chewing slows the pace of eating, increases saliva and the production of stomach juices. A responsible dieter feels no compulsion to eat everything on the plate and obeys the “stop eating” signals sent by a satiated body.

### BRIEF SUMMARY OF THE INVENTION

The goal of this invention is not quick weight reduction. It is a versatile, life style compatible weight management method that enables a dieter to gradually adopt the “sustainable and enjoyable eating practices” recommended by the American Dietetic Association. It provides for consumption of a natural, grain based, food blend containing high levels of IDF, SDF and a crunchy “chew inducing” element to encourage a habit of thorough chewing. The food blend is all natural and responds to the recommendation of FDA to increase consumption of dietary fiber. It also provides health benefits beyond weight loss. Those facts tend to encourage people concerned about their weight to try the diet.

Consumption of additional foods is neither mandated nor proscribed. No change in life style or abrupt modification of eating habits is required. A commitment to eat responsibly and to consume the appropriate amount of the high fiber food blend at times of day best suited to the dieter's life style is all that is needed. Consumption of the food blend promotes a long lasting sense of satiety and may inhibit, to some extent, energy metabolism of foods eaten. Over time, the dieter reduces consumption of other foods without discomfort to achieve a desired weight and to maintain that weight over time.

A sudden increase in dietary fiber consumption is known to cause gastrointestinal distress which is more severe if liquid intake is inadequate. Therefore, the dieter initially consumes a small portion of the natural high fiber food blend and is cautioned to drink increased amounts water, fruit juice or other liquids. Increases in daily consumption of the food blend proceeds at a comfortable pace until it reaches the full portion.

Some dieters may reach that full portion in about a week; others may require two weeks or more. Over time, the satiety conferred by the food blend facilitates subtle modification the dieter's eating behavior to a more healthful pattern without discomfort. Daily consumption of the full portion of the food blend continues until the desired weight is reached. Thereafter, the dieter continues to consume the high fiber food blend at a reduced level to foster continued adherence to the acquired healthy eating pattern which enables the dieter to maintain that weight indefinitely. Typically, the “full portion” of the food blend contains at least 40 grams of TDF so that total consumption of TDF from all sources may exceed 55 grams. However, some dieters may elect a smaller “personal full portion” to better suit their eating habits. The concept of the individualized personal full portion enhances the dieter's sense of control of the diet program.

### DETAILED DESCRIPTION OF THE INVENTION

Although dietary fiber is contained in a variety of fruits, vegetables, whole grains, beans, nuts and seeds, the food blend of this invention contains dietary fiber and functional fiber derived from grain, specifically oat, rice and corn. There are several reasons for this. Dietary fiber from oat, rice and corn is associated in the public's mind with breakfast cereals so that fibers from these grains may appeal to the many dieters who intend to consume the full portion of the food blend as a “breakfast cereal”. Recent advances in processing techniques for these grains have resulted in natural products containing higher concentrations of fiber. Newly available functional fibers extracted from these grains, exhibit very high levels of soluble fiber and have many of the same health benefits associated with intact dietary fiber found in grains, vegetables, legumes, and fruit. Soluble corn fiber is well tolerated even at very high intake levels. For example, Tate & Lyle's PROMITOR™ Soluble Corn Fibre is 85% soluble fiber is reported to be well tolerated at levels of consumption up to 65 g/day.

The food blend has an appealing “oaty” flavor and the dieter is encouraged to add fruits, nuts, berries and sweeteners according to taste. The food blend does not contain additives to increase shelf life. However, its shelf life is reasonable and consumers can extend shelf life by storing unused portions in their refrigerator.

Although wheat and barley contain significant amounts of dietary fiber, they are not preferred ingredients in the food blend because they also contain gluten. About 1% of Americans have celiac disease, a condition caused by an abnormal immune response to gluten. For these people, a gluten-free diet is essential. Oats processed or grown near wheat or barley may also contain gluten from these cereals. However, oats, grown and processed free of wheat and barley, are available. If a “gluten free” version of the food blend is required, these oats and oat products would be used.

Psyllium is a significant source of soluble dietary fiber. However, it is highly hydrophilic and can absorb 900 times its weight in water. It must be taken with a very large quantity of water. Ingestion of psyllium with insufficient water may result in sapping of saliva, choking and severe gastrointestinal distress. Although a small amount of psyllium could be incorporated into the high fiber food blend to increase SBF, the preferred ingredients of the food blend are derived from oats, rice and corn fibers.

The food blend contains about 25-30% SDF, a percentage that accords with the suggestion of the Federation of American Societies of Experimental Biology. The dieter may eat portions of the food blend at the times of day that best fit his lifestyle, incorporating it into a variety of dishes such as, pancakes, soups, gravies, yogurt, salads, stews and spaghetti sauce etc, thereby ensuring that daily consumption of the food blend is always tasty and enjoyable.

Some dieters may choose to consume the full portion of the food blend at the start of the day so that compliance with the program throughout the remainder of the day only requires eating responsibly. To accommodate those dieters, a full portion of the food blend should not significantly exceed one cup, an amount that most persons can comfortably consume at one sitting. Same versions of the food blend contain a functional fiber to achieve a total of at least 40 grams TDF in a one cup portion. Dieters, who elect to consume the full portion of the food blend at the start of the day, typically eat it as a breakfast cereal mixed with copious amounts of milk or fruit juice and topped with nuts and fruits of choice. They may microwave a milk and food blend mixture and consume it as a hot breakfast cereal having a taste and texture similar to traditional cooked oat meal. This illustrates another way in which the dieter may control the program to fit his or her personal preferences.

Those who find that a one cup portion is too large to consume at one sitting may adopt a “personal” full portion of ¾ cup. They will likely consume over 40 grams of TDF each day from all sources. Those who select that smaller “personal” full portion may progress toward their weight goal at a slower pace. However, avoiding a strict mandatory consumption requirement enhances the dieter's sense of control and fosters long term adherence to the program.

Table 1 lists the fiber content of some grain products that may be used in the food blend. The source for the dietary fiber data is the Department of Agriculture's data base. The data for the functional fibers is from the websites of the producers. The functional fibers listed are currently used to increase the fiber content of bakery products and energy bars but tend to be unappealing as the major ingredient in a “breakfast cereal”. To achieve a pleasing taste, texture and “mouth feel” and to promote thorough chewing, the food blend contains a substantial amount of oat bran and steel cut oats which, in combination, make up one half or more of the total weight of the food blend.

The functional fiber PromOte® Beta Glucan derived from non-GMO Swedish oats contains 35% oat bran fiber in the form of β-glucan. The soluble corn fiber Promitor® contains a very large percent of soluble corn fiber. A small quantity of either of those functional fibers may be included in the food blend to achieve the level of SDF needed in a volume that most people can comfortably consume at one sitting. The Food and Drug Administration (FDA) has approved a health claim for β-glucan soluble fiber for reducing plasma cholesterol levels and risk of heart disease. The fact that the packaging for the food blend may carry that claim is an additional inducement to try this weight management program.

TABLE 1

| | TDF Content | SDF Content | IDF Content |
|---|---|---|---|
| Ingredient | by weight | By weight | By weight |
| Steel cut Oats | 10.6% | 5% | 5% |
| Oat bran | 15.4% | 8% | 7% |
| Corn bran | 28% | 1% | 27% |
| Rice bran | 21% | 2% | 19% |
| Oat bran fiber | 35% | 35% | <1% |
| (B-glucan PromOat ®) | | | |
| Oat fiber | 89% | 2% | 87% |
| (e.g. SunOpta 200) | | | |
| Corn fiber | 79% | 2% | 77% |
| (e.g. SunOpta) | | | |
| Rice fiber | 93% | 1% | 92% |
| (e.g. SunOpta 310) | | | |
| Soluble Corn Fiber | 85% | 85% | <1% |
| (e.g. PROMITOR ® 85)) | | | |

Table 2 lists some of the grain fiber combinations (numbers rounded) suitable for the high fiber food blend of this invention. It is to be understood that the listings are illustrative only, and many additional combinations of these grain fibers can be used in practicing this invention. However, to achieve a pleasing taste, texture and “mouth feel” and to promote thorough chewing, the food blend must contain a substantial amount of oat bran and steel cut oats. In combination, those two ingredients make up one half or more of the total weight of the food blend. Optionally, additional steel cut oats may be consumed separately at various times of day in a variety of ways for example by sprinkling on salads or mixed with yogurt etc.

Examples 1 and 2 of Table 2 are illustrative of food blends designed to be consumed at a single setting. The volume of the “nominal portion” of each is about one cup and provides at least 40 grams of TDF. That portion may be adjusted to a lesser “full portion” to accord with the dieter's eating habits. Depending on volume of the “full portion” determined by the dieter, it may contain as little as 31 grams TDF. Dietary fiber from other foods eaten during the day would likely raise that dieter's total daily consumption to 45 grams or more. The third example in the table illustrates a food blend which the dieter may divide into two or more portions to be eaten at suitable times of day. It is almost twice the volume of examples 1 and 2 and contains more steel cut oats.

TABLE 2

| EXAMPLE 1 | | EXAMPLE 2 | | EXAMPLE 3 | |
|---|---|---|---|---|---|
| OAT BRAN | 40% | OAT BRAN | 45% | OAT BRAN | 64% |
| CORN Bran | 30% | OAT FIBER | 35% | CORN FIBER | 14% |
| OAT BRAN FIBER | 15% | SOLUBLE CORN | 10% | SOLUBLE FUNCTIONAL | 0% |
| β-GLUCAN | | FIBER | | FIBER | |
| STEEL CUT OATS | 15% | STEEL CUT OATS | 10% | STEEL CUT OATS | 22% |
| NOMINAL FULL | About 1 cup | NOMINAL FULL | About 1 cup | NOMINAL FULL | Over 1 ¾ cup |
| PORTION | | PORTION | | PORTION | |
| TDF | about 41 gm | TDF | about 42 gm | TDF | about 42 gm |
| SDF | about 11 gm | SDF | about 13 gm | SDF | about 11 gm |
| IDF | about 30 gm | IDF | about 29 gm | IDF | about 31 gm |

The food blend is retailed in 2 or 5 pound packages or single serve one cup packages. Larger quantities can be provided for institutional users. The dieter apportions daily consumption using a measuring cup found in most households While this may not be as accurate as weighing each portion, it is much simpler and any errors are trivial and non-cumulative.

During the weight loss stage of the program (described below) a full portion of the high fiber food is consumed each day—at various times of day or at one meal, usually breakfast. On the initial day of the diet, ¼ cup is consumed. The dieter increases that amount in comfortable increments until a full portion of the high fiber food blend is eaten each day. The “nominal” full portion of the food blend designed to be consumed at one meal is one cup. Since the average American consumes about 15 grams of fiber each day, TDF consumed by the dieter from all sources each day may be as much as 55 grams. Furthermore, the dieter may adapt that nominal full portion to a smaller “personal” portion size that accords with the dieter's eating habits. A person who adopts a personal full portion of ¾ cup will likely consume over 40 grams of TDF each day from all sources.

The dieter is required to do three things: eat the appropriate portion of the high fiber food each day, drink plenty of fluids (water) eight to ten glasses each day and commit to “eat responsibly”. Responsible eating reinforces the dieter's sense of control which promotes adherence to the diet program and ultimately leads the dieter to reduce portion size at meals and snacks throughout the day. There are no mandatory restrictions on the time, quantity, or types of additional food consumed. Even snacking is allowed. However “mindless munching” (e.g. watching TV with a box of treats and casually munching until the entire box is consumed) is strongly discouraged. A responsible eater asks “how much” before eating and chews thoroughly while eating. As a dieter considers “How much snack food do I want now?” he or she may be prompted to think “I am not hungry, should I forgo the snack?” At meal time, the responsible dieter considers whether to order the smaller steak or perhaps to forgo dessert, and feels no compulsion to finish everything on the plate.

The Program Stages

The program is divided into three stages plus an optional fasting stage for those individuals who wish to accelerate their weight loss.

1. The start-up stage.

During this stage the dieter gradually increases intake of the high fiber food until it reaches the full portion. On the first day the dieter consumes ¼ cup of the food blend mixed with milk or juice to a watery consistency—much more watery than typical breakfast oatmeal. Consumption is increased gradually on succeeding days. The amount of fiber consumed must be increased gradually and the dieter must drink large amounts of liquid. Adding fiber too quickly or drinking insufficient liquid with the food blend and throughout the day may cause gas, bloating, cramps and diarrhea or even intestinal blockage. When daily consumption of the food blend reaches the full portion level determined by the dieter, the weight loss stage begins. The dieter may have experienced some weight loss during the latter part of the first stage.

2. The weight loss stage.

The dieter consumes a full portion of the food blend each day. Depending on the weight loss goal and the size of the full portion, this stage may last from 6 months to a year or more. During this stage, the dieter continues to do three things; consume the appropriate amount of high fiber food with sufficient liquid each day in the manner and at times of his or her choosing, drink adequate quantities of liquid during the day and eat responsibly. Consumption of the fiber rich food blend provides a lasting sense of satiety and encourages thorough chewing of all foods. The dieter may eat other foods, without restriction as to kind or quantity. A dieter committed to losing weight eats responsibly and thereby gradually reduces the quantity of food consumed throughout the day without discomfort. Eventually, the dieter adopts a pattern of healthier eating habits

3. The maintenance stage.

Upon achieving the weight goal, the dieter gradually reduces daily consumption of the fiber blend to a level appropriate to maintain ideal weight. Fiber consumption may depend upon the person's level of physical activity; but consumption of TDF from all sources should not be reduced below 35 grams per day. The dieter has now acquired more healthy eating habits and consumes sufficient dietary fiber to maintain desired weight indefinitely.

4. An optional fasting stage

Persons in the weight loss stage may elect to accelerate their weight loss for a variety of reasons. On the chosen “fasting day” the dieter consumes the full portion of the food blend and drinks plenty of water, but no additional food is taken. The satiety conferred the ultra high dietary fiber blend enables the dieter to fast for 24 hours with minimal discomfort. A dieter may elect to observe one or two fasting days per week or choose to fast one day per month.

### ILLUSTRATIVE EXAMPLES

The following examples illustrate the ways in which the diet conforms to a dieter's lifestyle.

1. An engineer finds that her increasing professional responsibilities are impacting the time available for her exercise regime and that attending staff luncheons, engineering association dinners, and extensive professional travel make it difficult to adhere to a healthy diet. As a result, she is gradually gaining weight and decides to try the diet program of this invention. She finds that eating a full one cup portion of the ultra high dietary formulation with plenty of skim milk followed by orange juice, toast and coffee each morning perfectly fits her lifestyle. When she travels, she takes with her a package of the food blend and consumes a cup in her hotel room before joining clients or coworkers for breakfast in the hotel dining room. The luncheons and dinners required in her professional life continue as before, but she finds that because of the long, lasting satiety conferred by the diet she no longer wishes to eat everything on her plate. Thus, she gradually achieves her desired weight and is able to maintain that weight indefinitely,

2. A stay-at-home dad takes care of the family home and children. He could adopt the “one and done” breakfast mode of the diet of example 1, but is concerned that other members of the family should also be consuming more dietary fiber. He opts to consume ½ of the food blend when his spouse is at work and the children are in school and the remainder at the family's breakfast or dinner meal. Since the formulation can be incorporated into a wide range of foods such as breakfast cereal, pancakes, soups, gravies, yogurt, salads and spaghetti sauce, other members of the family now consume higher levels of dietary fiber in a variety of tasty dishes. Because of the long lasting satiety conferred by the diet and his commitment to eat responsibly, he finds that he eats less snack food during his evening TV viewing.

3. A lawyer is gaining weight and decides to get back into shape by exercising more and eating less. He adopts the strategy chosen by the engineer in example 1. After six months he is pleased with his gradual weight loss. The local Bar Association is sponsoring a 10K race and he decides to accelerate his weight loss in order to compete. He talks with his doctor and they agree that fasting on Tuesday and Friday of each of the three weeks preceding the event would be appropriate. On race day he is closer to his optimum weight. He continues on the diet determined to compete at his optimum weight next year.

I claim:

1. A life-style compatible weight management method for a dieter committed to eating responsibly that does not mandate or prohibit consumption of particular foods and promotes thorough chewing comprising the following steps in the order named, on the first day consuming at breakfast a relatively small quantity of a grain based high-fiber food blend containing at least 40 grams of dietary fiber per cup and consisting essentially of a natural source of soluble dietary fiber, a natural source of insoluble dietary fiber and a natural chew inducing grain, gradually increasing consumption of the food blend at breakfast on successive days until consumption of the food blend reaches a full portion having a volume of one cup or such lower quantity, not less than ¾ cup, that the dieter selects as a personal full portion, continuing to consume the selected full portion of the food blend on successive days until a desired weight is achieved, and thereafter adjusting daily consumption of the food blend to maintain that desired weight.

2. The weight management method of claim 1 which includes one or more fasting days per week during which no food in addition to the full portion of the high fiber food blend is consumed.

3. A natural high fiber food blend for use in a life-style compatible weight management program in which a one cup portion contains at least 40 grams of dietary fiber of which at least 10 grams is soluble dietary fiber.

4. The high fiber food blend of claim 3 which contains soluble corn fiber or β-glucan, and a mixture of oat bran, raw steel cut oats, and one or more of corn bran, oat fiber and rice fiber.

5. The high fiber food blend of claim 3 in which at least 50% of the food blend is oat bran and steel cut oats.

6. A life-style compatible weight management method for a dieter committed to eating responsibly that does not mandate or prohibit consumption of particular foods and promotes thorough chewing, comprising the following steps in the order listed, on the first day consuming a relatively small quantity of a grain based high-fiber food blend consisting essentially of a natural source of soluble dietary fiber, a natural source of insoluble dietary fiber and a natural chew inducing grain, gradually increasing the quantity of the food blend consumed on successive days at times of day selected by the dieter until the quantity of food blend consumed each day contains at least 40 grams of dietary fiber, continuing to consume that quantity of the food blend on successive days until a desired weight is achieved, and thereafter adjusting daily consumption of the food blend to maintain that desired weight

7. The weight management method of claim 6 in which the grain based high-fiber food blend comprises a mixture of oat bran, raw steel cut oats and one or more of corn bran, oat fiber and rice fiber.

8. The weight management method of claim 6 which includes one or more fasting days per week during which, no food in addition to the high fiber food blend is consumed
